(19) United States
(12) Patent Application Publication
(10) Pub. No.: US 2008/0069989 A1
(43) Pub. Date: Mar. 20, 2008

(54) RUST-INHIBITING INJECTION MOLDED OBJECTS

(76) Inventor: Robert Hammill, Kent, OH (US)

Correspondence Address: QUARLES & BRADY LLP, 33 E. MAIN ST, SUITE 900, P.O BOX 2113, MADISON, WI, 53701-2113, US

(21) Appl. No.: 11/848,478

(22) Filed: Aug. 31, 2007

Related U.S. Application Data
(60) Provisional application No. 60/841,732, filed on Aug. 31, 2006.

(51) Int. Cl. C08K 3/28; B29C 45/00; C08K 5/3492; C08K 5/3495

(52) U.S. Cl. 428/35.7; 106/14.05; 264/328.17; 524/100; 524/429; 524/430; 524/543; 524/577; 524/582; 524/585; 524/91

(57) ABSTRACT

An injection molded object with corrosion inhibiting properties that includes an injection molded element having at least one approximately rigid wall, where the at least one wall includes a material which has at least one plastic polymer, and at least one volatile corrosion inhibitor. The material comprises between about 0.5% and 30.0% by weight of the at least one volatile corrosion inhibitor, and between about 70.0% and 99.5% by weight of the at least one commodity-grade, plastic polymer. The amount of the polymer can be adjusted to accommodate additional components in the material.

### CROSS-REFERENCE TO RELATED APPLICATION

This application claims a priority benefit to U.S. Provisional Patent Application Ser. No. 60/841,732, filed Aug. 31, 2006, incorporated herein by reference as if set forth in its entirety.

### STATEMENT CONCERNING FEDERALLY SPONSORED RESEARCH OR DEVELOPMENT

Not applicable.

### BACKGROUND OF THE INVENTION

The present invention is directed to plastic objects fabricated from commodity grade plastics blended with volatile corrosion inhibitors (VCIs), and injection molding methods of manufacture thereof.

Flexible films incorporating VCIs have been available and are used widely for the protection of metallic articles in storage and shipping. Such applications are especially useful for sensitive electronic media devices and other delicate metallic articles. Paper has also been coated with VCIs and is used extensively for protection of metallic articles during storage and shipping. Vapor phase corrosion chemicals are also available in small pellets and packages, and may also be impregnated into plastic foam to provide other methods or protection. All of the above methods, however, are typically temporary in nature.

Reference is made to the following patents and publications:

US Patent Application Publication No. 2003/0213936 (Kubik el al.), incorporated herein by reference as if set forth in its entirety, discloses a corrosion-inhibiting formula that comprises a mixture of at least one VCI, at least one anti-oxidant, at least one alkali and fumed silica. Additionally, the corrosion-inhibiting formulas can be placed in any suitable polymer film and/or polymer article. If desired, this mixture can be further processed by extrusion and co-extrusion. In the examples, methods of extrusion occurred at temperatures above 200° F. and 300° F., resulting in little degradation of corrosion-inhibiting properties. In example 2, the formula of 3% VCI formed a corrosion-inhibiting compound.

US Patent Application Publication No. 2003/0207974 (Kubik et al.), incorporated herein by reference as if set forth in its entirety, discloses tarnish-inhibiting formulas that comprise a mixture of at least one carrier, at least one strong alkali compound and at least one additional compound, which yield an insoluble compound. These mixtures can also include additional additives such as anti-oxidants and corrosion-inhibitors. This mixture, if desired, can be combined with a suitable amount of additional polymer or resin and further processed by known techniques like extrusion, co-extrusion, coating, casting, etc. to produce a polymer film or polymer article.

U.S. Pat. Nos. 7,112,169 (Honstrator) and 6,591,980 (Honstrator), each of which is incorporated herein by reference as if set forth in its entirety, disclose a system and method for preparing a plastic bag especially useful for carrying electronic objects. The bags were made with a percentage of VCI, or an anti-static material, which sublimed into the bag volume. The plastic bags further had internal ribbings that increased the surface area. The additional surface area increased the exposure of the object in the bag to the VCI or anti-static material that sublimes into the cavity.

'169 and '980 also disclose methods in which additives are introduced into the plastic mass from which the bag is created. The additive (i.e., VCI) was introduced and mixed into the plastic before fed through an extrusion die. Typically, mixing occurred by use of a screw that advanced raw material toward the extrusion die and mixed it during the process. Once the plastic was extruded as the bag, the VCI was mixed uniformly throughout the film of the bag. '169 and '980 also disclose a higher ratio of VCI in the bag relates to more VCI outgassing over time into the bag. '169 and '980, however, do not disclose a percentage weight-to-weight or volume-to-volume of VCI that is added to the plastic.

U.S. Pat. No. 5,715,945 (Chandler), incorporated herein by reference as if set forth in its entirety, discloses a method and an apparatus for enclosing and protecting a metal object against corrosion while sealed within a skin film or blister package envelope utilizing vapor phase corrosion inhibitors. A thin film of thermally activated adhesive was mixed with a vapor phase corrosion inhibitor and applied to the surface of a substrate. The VCIs used in the adhesive were blends of alkali metal molybdates, alkali metal nitrites, triazoles and amine salts. The VCIs were blended with resins that comprise the skin film and blisters for the blister pack operations, and occurred prior to extrusion, using VCI powder. The resins comprised a copolymer of ethylene and a vinyl monomer. The blister packs were made from PVC resin and cellulose acetate butyrate resin.

U.S. Pat. No. 6,555,600 (Sobkin et al.) and US Patent Application Publication No. 2001/0016615 (Sobkin et al.), each of which is incorporated herein by reference as if set forth in its entirety, disclose two formulas of VCIs. The first formula included cyclohexylammonium benzoate, sodium nitrite, sodium sebacate and benzotriazole. The second formula was the same as the first formula, except that it lacked benzotriazole. Because the VCIs were volatile, they sublimed and created a vapor that accumulated onto available surfaces. The VCIs chemically prevent rust formation on metallic surfaces.

VCIs have been provided in injection molded articles, but only when high-melting temperature, engineered plastics are used. These plastics, however, are expensive to manufacture, and the cost of these plastics are carried through to end-use production and manufacturing. Thus, any corrosion-protective item made from engineered plastics will maintain a very high price that significantly reduces the sales and marketability of such products.

'600 and '615 use this combination. Likewise, '600 and '615 disclose higher melting temperature, engineered plastics, such as nylon polyesters and polycarbonate resins that are blended with selected higher-melting, corrosion-inhibiting chemicals in masterbatch formulations. The ratio described is 85 parts resin to 15 parts inhibitors. This masterbatch can be blended further with the resin to produce a working formulation or mix containing 1 to 7.5% inhibitors, the balance being resin and the formulation being suitable for injection molding. '600 and '615 disclose a method of preparing a masterbatch using a twin screw extruder, mixing pelleted plastic and pelleted anti-corrosion materials. Once an appropriate percentage of corrosion inhibitor is obtained, the masterbatch is injection molded into objects. The melting point of the base resin is such that the selected corrosion inhibitor remains soluble, is not released, and does not become fugitive during exposure to conditions required in the injection molding operation.

In addition, '600 and '615 disclose high-temperature, engineered plastics that include specific percentages of VCIs that will not sublime at higher manufacturing temperatures. The limitation in '600 and '615 is the high production cost of engineered plastics.

As noted above, the prior art is limited to using high-cost, engineering plastics and VCIs that burn off at temperatures commonly used in injection molding. A significant need exists for methods mid resultant injection molded objects that utilize common, low-cost plastics and VCIs.

### BRIEF SUMMARY

The present invention arises from the inventor's appreciation that a class of VCIs is unexpectedly retained in solid objects formed from commodity-grade, plastic polymers in a mixture for use in an injection molding process. In contrast, other VCIs do not survive injection molding conditions and are not retained in injection molded objects formed using commodity-grade plastics.

Corrosion-inhibiting plastics can be prepared by blending selected VCIs with selected plastic polymers to form a mixture. The mixture can be used with injection molding to produce objects having VCIs semi-permanently encapsulated or partially solubilized within the mixture. As the incorporated VCIs leach out (i.e., volatilize) from the objects at a slow rate (e.g., one to five years), they coat surfaces of nearby metallic or rust-prone objects and form a protective barrier that inhibits rust formation over an extended period of time. Molded objects can be tested to ensure that the VCIs leach out at a desired leaching rate. However, adjustment of the percentages of the VCIs may be necessary depending upon the object's architecture and the desired leaching rate.

In a first aspect, the present invention is summarized as an object having corrosion-inhibiting properties that includes at least one commodity-grade plastic polymer and at least one VCI. The object is not a thermoformed object (e.g., an extruded film or a coating), but rather an object having a measurable, and even variable, thickness, such as is formed in an otherwise conventional injection molding process. Advantageously, injection molding can create intricate shapes, which are not possible in thermoforming, including varying thickness and surface architectures within that individual object. The injection-molded object can be a multifaceted enclosure having inter alia a top panel, a bottom panel and at least three side panels, where the top panel, the bottom panel, and/or the at least three side panels includes the material as previously described. Alternatively, the injection molded object can be a divider or an insert or a tray sized and shaped for use in a multifaceted enclosure, or other elements used in such enclosures. At least one injection molded component of the object is formed in a process as described and contains the VCI(s) in the plastic polymer. In some embodiments, the entire object is formed of a corrosion-inhibiting, plastic polymer.

The object can advantageously include between about 0.5% and about 30.0% by weight of the at least one VCI, or between about 1.0% and about 7.5% by weight of the at least one VCI, or between about 1.0% and about 3.5% by weight of the at least one VCI, or about 3.0% by weight of the at least one VCI.

Likewise, the weight percent of the commodity-grade, plastic polymer or polymers can vary from those noted above if the object contains one or more additional ingredients, such as at least one antioxidant, alkali-earth metal silicate, alkali-earth metal oxide, alkaline-earth metal silicate, alkaline-earth metal oxide and fumed silica. In addition to the commodity-grade, plastic polymer and VCI, the mixtures can also include other ingredients including, but not limited to, colorings, preservatives, elasticizers and the like.

The plastic polymer can be individual, commodity-grade, plastic polymers or mixtures thereof. The VCI can be inorganic nitrite salts, triazole compounds and mixtures thereof; sodium nitrite, potassium nitrite, barium nitrite and mixtures thereof; or benzotriazole, tolyltriazole, sodium tolyltriazole and mixtures thereof; and/or mixtures of any of the above. Alternatively, the VCI can be, e.g., Zerust®.

In a second aspect, the present invention is summarized as a method of preparing a composition for use in injection molding an object with corrosion-inhibiting properties, which includes mechanically blending at least one VCI with at least one commodity-grade, plastic polymer to produce a substantially homogeneous mixture of the at least one VCI and the at least one plastic polymer, in a desired weight ratio, as noted supra. The components can be provided in pellet, granular, powder or other form suitable for blending.

In a third aspect, the present invention is summarized as a method of injection molding an object with corrosion-inhibiting properties, which includes melting a substantially homogeneous mixture of a VCI and a commodity-grade, plastic polymer, in a desired weight ratio, and injecting tie melted mixture into a mold suitable for forming the object.

These and other features, aspects and advantages of the present invention will become better understood from the description, that follows. The description of preferred embodiments is not intended to limit the invention to cover all modifications, equivalents and alternatives. Reference should therefore be made to the claims herein for interpreting the scope of the invention.

### DETAILED DESCRIPTION OF PREFERRED EMBODIMENTS

The present invention blends at least one VCI with at least one commodity-grade, plastic polymer/resin to produce a mixture suited for use in forming injection-molded objects having corrosion-inhibiting properties. The invention also includes injection molding methods for subjecting the blended mixture to an injection molding process. The invention also includes the resultant injection-molded objects formed of a commodity-grade plastic containing at least one VCI and having corrosion-inhibiting properties. The resultant objects produced via this method may also include additional materials to create a finished product, such as: hinges, screws, bolts, latches, storage dividers, utility box dividers, drawers, compartments, etc., or the resultant objects produced via this method may be the individual items just mentioned, or other like parts.

### Ingredients

The present invention utilizes low-cost, commodity-grade plastics as a base resin. In contrast to other grades of plastics, such as engineering plastics, commodity-grade plastics are characterized by common, inexpensive monomers that polymerize at low cost to create long chain polymers. Commodity-grade polymers such as polyethylene, polypropylene, polyvinyl chloride and polystyrene are advantageously utilized inasmuch as they are compatible with and may be readily filled with a quantity of selected granular, pellet or powder form corrosion inhibitor (e.g., VCI).

The melting point of the polymer is such that the selected corrosion inhibitors remain soluble, are not released, and do not become fugitive during exposure to conditions encountered in the injection molding operation. Typically, the percentage of VCI added in the mix before molding is the percentage of VCI remaining after molding. Because heat is the catalyst that softens and allows the pellets to mix, there is no chemical reaction to cause a significant loss of properties or product during the process. The process intermingles the VCI additive with the polymer during the melting phase of molding when heat is induced. Heat is then liberated during the cooling process. The only loss is a normal, minute amount of VCI leached as a function of time. Such a combination of properties is important because exposure to relatively high temperatures for finite periods of time, such as during a molding operation, is normally adequate to cause certain corrosion-inhibiting compounds, when combined with other resins, to flash, sublime or otherwise become lost during the molding process. By using carefully selected corrosion inhibitors and commodity-grade plastics together with appropriate blending and masterbatch techniques, a suitable molding material may be made from these polymers with the selected corrosion-inhibiting compounds being retained in the plastic matrix throughout the process.

Preferred VCIs, available from Northern Technologies International Corp. (Lino Lakes, Minn.) and sold under the name, Zerust®, combine effectively and unexpectedly with the commodity-grade plastics without sublimation or flashing to produce objects that retain effective corrosion protection. However, as described in U.S. Pat. No. 6,555,600 (Sobkin et al.) and US Patent Application Publication No. 2003/0213936 to (Kubik et al), VCIs can be composed of different formulations, such as:

Formula 1:

| | |
|---|---|
| Cyclohexammonium benzoate | 6% |
| Sodium nitrate | 25% |
| Sodium sebacate | 65% |
| Benzotriazole | 4% |

Formula 2:

| | |
|---|---|
| Cyclohexammonium benzoate | 8% |
| Sodium nitrate | 27% |
| Sodium sebacate | 65% |

The present invention includes the use of these, and any other alternative formulations of VCIs, and it is within the scope of the present invention to use other non-proprietary VCIs.

### Process

In accordance with tie present invention, selected, commodity-grade plastic polymers can be blended with selected VCIs in a masterbatch formulation within a range of about 0.5% to about 30.0% VCIs by weight (the balance being the polymer and other components). Alternatively, the present invention includes a formulation containing VCIs within a range of about 1.0%/, to about 7.5% by weight (the balance being the polymer and other components); or includes a formulation containing VCIs within a range of about 1.0% to about 3.5% by weight (the balance being the polymer and other components). This formulation is suitable for injection molding.

The ingredients are combined with an injection molding procedure. The basic steps of a preferred manufacturing process begins with pelletizing a VCI into small, plastic pellets. Although preferred VCIs are available under the Zerust® trademark, it is within the scope of the invention to use other non-proprietary VCIs, as described elsewhere herein. The plastic pellets are selected from a variety of commodity-grade plastics, such as polyethylene or polypropylene. The anti-rust pellets are then mechanically blended with commodity-grade plastics into a homogenous pellet mixture. This is typically accomplished in a tumbling blender or hopper mixer, as is known in the art.

The pellet mixture is heated between 370° F. to 480° F. (dependent upon the commodity-grade plastic selected) in the barrel, a long heated cylinder, to form a viscous, substantially homogenous mixture with a preferred concentration within the range of about 0.5% to about 3.5% w/w (VCI/bulk plastic). As the mixture is forced through the barrel by the screw, the VCI pellets blend with the plastic pellets to form a substantially homogenous mixture with the anti-rust product throughout the polymer compound. After passing through the barrel, the homogenous polymer blend is forced through an internally-tapered nozzle and injected into a closed-mold having a pre-selected part design. The viscous VCI/plastic mixture fills the mold and after cooling solidities and retains the shape of the mold. Stock temperature, however, should stay below 500° F. and shear heat should be monitored to watch for resin mix burn during the injection cycle. The resultant object retains and emits the rust inhibiting vapors over time. Metal surfaces placed inside molded objects, or proximate to objects manufactured according to the present invention, are coated with the rust inhibiting vapors and retain the rust-inhibiting properties.

### EXAMPLES OF OBJECTS

All of the objects produced by the methods described herein emit rust inhibiting vapors. The use of commodity-grade plastics is significant because it reduces the overall cost of the final product and opens up a new range of cost-sensitive products that can be injection molded in combination with VCIs.

Typical objects prepared according to this invention include tool boxes, fishing tackle boxes, utility boxes or other storage containers used in a marine environment, enclosures for electronic devices and/or articles, enclosures for delicate electronic systems, and other injection molded pieces utilized in enclosing and protecting metallic articles against corrosion from corrosive elements in the atmosphere and/or ambient environment. These enclosures typically comprise multi-faced enclosures fabricated from top, bottom and side panels that are, in turn, prepared pursuant to the features of the present invention. In addition, separate dividers and replacement liners that fit into other storage devices can be produced via the method of the present invention, or hinges, screws, bolts, latches, storage dividers, utility box dividers, drawers, compartments, etc. produced via the methods described herein, which can be used separately, or with VCI containers according to the present invention.

The addition of separate dividers, replacement liners, etc., made via the method of the present invention impart to non-VCI containers the properties of the VCI article. Furthermore, the addition of new VCI articles rejuvenates older VCI containers, which, over years, lose some rust-inhibiting characteristics. Therefore, the present invention provides an improved molding compound created from commodity-grade plastic polymers capable of receiving and retaining a vapor phase corrosion inhibitor.

While example embodiments and applications of the present invention have been illustrated and described, including a preferred embodiment, it is to be understood that the invention is not limited to the precise configuration and resources described above. Various modifications, changes, and variations apparent to those skilled in the all may be made in the arrangement, operation, and details of the methods and systems of the present invention disclosed herein without departing from the scope of the claimed invention.

I claim:

1. A corrosion-inhibiting object, comprising:
at least one commodity-grade, plastic polymer; and
at least one volatile corrosion inhibitor.

2. The object of claim 1, wherein the object comprises between about 0.5% and about 30.0% by weight of the at least one volatile corrosion inhibitor.

3. The object of claim 1, wherein the object comprises between about 1.0% and about 7.5% by weight of the at least one volatile corrosion inhibitor.

4. The object of claim 1, wherein the object comprises between about 1.0% and about 3.5% by weight of the at least one volatile corrosion inhibitor.

5. The object of claim 1, wherein the object comprises about 3.0% by weight of the at least one volatile corrosion inhibitor.

6. The object of claim 1, wherein the at least one commodity-grade, plastic polymer is selected from the group consisting of polyethylene, a polypropylene, a polyvinyl chloride, a polystyrene and a mixture of any of the foregoing.

7. The object of claim 1, wherein the at least one volatile corrosion inhibitor comprises at least one of an inorganic nitrite salt and a triazole compound.

8. The object of claim 1, wherein the at least one volatile corrosion inhibitor comprises at least one of sodium nitrite, potassium nitrite and barium nitrite.

9. The object of claim 1, wherein the at least one volatile corrosion inhibitor comprises at least one of a benzotriazole, a tolyltriazole and a sodium tolyltriazole.

10. The object of claim 1, wherein the at least one volatile corrosion inhibitor comprises Zerust®.

11. The object of claim 1, further comprising at least one antioxidant; at least one of an alkali-earth metal silicate, an alkali-earth metal oxide, an alkaline-earth metal silicate and an alkaline-earth metal oxide; and fumed silica.

12. The object of claim 1, wherein the object is a multifaceted enclosure having a top panel, a bottom panel, and at least three side panels, at least one of the top panel, the bottom panel, and the at least three side panels comprising the polymer and the volatile corrosion inhibitor.

13. The object of claim 1, wherein the object is an insert adapted in size and shape for use in multifaceted enclosure.

14. A method of making a corrosion-inhibiting object, comprising the steps of:
mechanically blending at least one volatile corrosion inhibitor with at least one commodity-grade, plastic polymer to produce a substantially homogeneous mixture; and
introducing the substantially homogenous mixture under injection molding conditions into a mold sized and shaped to form the object.

15. The method of claim 14, wherein the substantially homogenous mixture comprises between about 0.5% and about 30.0% by weight of the at least one volatile corrosion inhibitor.

16. The method of claim 14, wherein the substantially homogeneous mixture comprises between about 1.0% and about 7.5% by weight of the at least one volatile corrosion inhibitor.

17. The method of claim 14, wherein the substantially homogeneous mixture comprises between about 1.0% and 3.5% by weight of the at least one volatile corrosion inhibitor.

18. The method of claim 14, wherein the substantially homogeneous mixture comprises about 3.0% by weight of the at least one volatile corrosion inhibitor.

19. The method of claim 14, wherein at least one of the volatile corrosion inhibitor and the plastic polymer is provided in pellet form.

20. The method of claim 14, wherein the at least one commodity-grade, plastic polymer is selected from the group consisting of polyethylene, a polypropylene, a polyvinyl chloride, a polystyrene and a mixture of any of the foregoing.

21. The method of claim 14, wherein the at least one volatile corrosion inhibitor comprises at least one of an inorganic nitrite salt and a triazole compound.

22. The method of claim 14, wherein the at least one volatile corrosion inhibitor comprises at least one of sodium nitrite, potassium nitrite and barium nitrite.

23. The method of claim 14, wherein the at least one volatile corrosion inhibitor comprises at least one of a benzotriazole, a tolyltriazole and a sodium tolyltriazole.

24. The method of claim 14, wherein the at least one volatile corrosion inhibitor comprises Zerust®.

25. The method of claim 1, wherein the substantially homogenous mixture further comprising at least one antioxidant; at least one of an alkali-earth metal silicate, an alkali-earth metal oxide, an alkaline-earth metal silicate and an alkaline-earth metal oxide; and fumed silica.
